(19) United States
(12) Patent Application Publication
(10) Pub. No.: US 2007/0096410 A1
(43) Pub. Date: May 3, 2007

(54) Tri Control Platform Device

(75) Inventor: Adam M Spencer, Parker, CO (US)

Correspondence Address: ADAM M. SPENCER, 3773 DOGWOOD AVE., PARKER, CO, 80134, US

(73) Assignee: OHSKI, LLC, Parker, CO (US)

(21) Appl. No.: 11/163,893

(22) Filed: Nov. 3, 2005

(51) Int. Cl. B62B 13/00

(52) U.S. Cl. 280/14.21; 280/87.041

(57) ABSTRACT

A tri platform control device on which a rider stands on to either ski or skate. The device includes a front vertical platform, two lateral platforms with footpads attached. Attached to the footpads are either wheels or skis. The vertical platform has a steering shaft fitting allowing the front ski to turn and collapse in case of a sudden impact, giving a safer ride. A spring loaded hub device attaches the lateral platforms to the vertical platform. This device adjusts the vertical platform. It is also used to fold the platforms up. The spring and hub assemblies on the vertical platform allow the parallel skis to lean from side to side. This device also allows the rider to lift the front ski off the ground to avoid obstacles. The footpad enables riders to push either the toe or heal down for better performance. An additional version has adjustable lateral platforms.

### CROSS-REFERENCE TO RELATED APPLICATIONS

Not Applicable

### FEDERALLY SPONSORED RESEARCH

Not Applicable

### SEQUENCE LISTING OR PROGRAM

Not Applicable

### BACKGROUND OF THE INVENTION

1. Field of Invention

This invention relates to ski devices, specifically to a tri platform control device, which allows a person to stand on while skiing.

2. Prior Art

In recent years the popularity of the cambering vehicle and mechanism with wheels for sport and recreation has increased. In addition, a three-point platform device has been developed with skis for use in the snow. It enables a beginner to ski the slopes quickly.

Both of these devices use a universal joint to attach the lateral platforms to the vertical platforms. The universal joints in the frame permit its steering head and handles to swing from side-to-side. This cambering creates an artificial down slope, which allows the vehicle to move forward. The universal joint is intended to allow the wheels or skis to remain parallel through out the ride down the hill. However, the wheels or skis attached to the platforms have a tendency to move at different angles. It is especially noticeable while skiing the edges. The steering bar is fixed for and aft. This changes the position of the rear skis when you pick up the front of the vehicle. This could cause the rider to fall backwards. In addition, since the steering bar is stationary it can be dangerous if a rider falls forward onto it. Instead of collapsing, it would hit the rider in the chest. Also, the only way to steer the device is to turn the vertical platform either clockwise or counterclockwise.

Further, the foot platforms are also fixed. The angle of the toe cannot be changed, which makes it difficult to avoid obstacles. It can also cause you to tumble over the handlebars. You cannot transfer your weight forward or aft either. Therefore, you cannot change the balance on the skis or wheels. Thus, it does not allow you to float the ski in snow. This does not imitate parallel skating or skiing. Therefore, the manipulation of the wheels or skis cannot be transferred to downhill riding.

In addition, the ski device does not fold up. Therefore, it could be cumbersome and awkward for the rider to get onto the ski lift with this device. While you are sitting on the ski lift, most of the device is dangling below you. You must hold onto the device while sitting on the lift, so depending on the strength of the rider, this could make it difficult to hold onto. This device also has many parts and welded parts making it expensive to manufacture.

### BACKGROUND OF INVENTION—OBJECTS AND ADVANTAGES

The tri platform control device solves many problems over the previous art. The unique spring and hub assemblies allow the vehicle to more closely imitate skiing. They allow the lateral platforms to stay parallel to one another while skiing the edge. It also has a locking gear located in the hub assembly. This allows the vertical platform to adjust to different angled positions. This allows for rider comfort. There is a locking gear on the vertical platform. It is designed to under a certain amount of pressure during a fall. Thus avoiding hitting the rider in the chest. This adds greater safety for the rider. This device also allows the rider to lift up the front ski without affecting the rear skis. This allows the rider to avoid obstacles without the danger of falling backwards.

In addition, the unique hub assemblies on this tri platform control device also allow it to be folded up. This makes it easy to carry to and from the ski area as well as on the ski lift. It also makes it convenient to store. The hub also has integral attach rings on the front and back. This allows the attachment of a rope so that you can tow or be towed. The footpad assembly has a spring pin. It enables the rider to push either the toe, or heal down. The platforms can rotate forward and aft. This allows the rider to balance naturally on the platform. This allows the rider to change the angle of the ski for better performance. This enables the rider to go over bumps easier. The spring pin also works so that the ski returns to its original position. The spring, hub, and footpad assemblies work together to provide a safer and easier ride. They also allow the vehicle to imitate downhill skiing.

In addition to the above version, there are two other versions. One version has adjustable lateral platforms. This version gives even more options to the rider. It allows the rider to adjust the width for individual rider comfort. The width adjustment also can be narrowed for skiing steeper terrain. The other version has wheels and works in the same manner as the ski version.

This device also has other advantages. There are no welded parts on this device making it less costly to manufacture. The center hub has springs instead of a molded shock-absorbing joint. The springs do not dissipate the energy from one turn to another as the shock-absorbing joint does. This allows for a more fluid turn at greater speeds. This also makes it easier to manufacture. Parts can be made by various manufactures and sent to one place to be assembled.

The advantages of the tri platform control device will become apparent from a consideration of the ensuing description and drawings.

### SUMMARY

The present invention provides a ski tri platform control device that offers people the opportunity to ski the slopes more quickly than traditional downhill skiing. It is designed so a novice skier can use on the ski slopes within a short amount of time. It also offers the experienced skier a new way to ski the slopes giving them more of a variety. All age groups can use the tri platform control device, as well as all skill levels. This equipment has advantages over downhill skiing. It allows people to ski safer, easier. Also, there is no need for the use of heavy boots and skis attached to your feet. There is also a wheeled version, which operates in the same manner as the ski version.

### BRIEF DESCRIPTION OF THE DRAWINGS

A fuller understanding of the nature and objects of the present invention will become apparent upon consideration of the following detailed description taken in connection with the accompanying drawings, wherein:

FIG. 1 is a perspective view of the tri-control platform device with skis.

FIG. 2 is a detailed perspective view of the tri-control platform device with skis.

FIG. 3 is a detailed perspective view of the spring hub assembly.

FIG. 4 is a detailed exploded view of the front spring assembly.

FIG. 5 is a detailed exploded view of the spring hub assembly.

FIG. 6 is a detailed view of the lateral platform with a footpad assembly and ski attached.

FIG. 7 is a detailed exploded view of the footpad assembly.

FIG. 8 is a perspective view of an adjustable lateral platform.

FIG. 9 is a detailed exploded view of the front spud and hub assembly for the adjustable lateral platform.

FIG. 10 is a detailed exploded view of the link assembly for the adjustable lateral platform.

FIG. 11 is a detailed perspective view of the tri-control platform device with wheels.

FIG. 12 is a detailed perspective view of the front wheel assembly.

FIG. 13 is a detailed perspective view of the rear wheel assembly.

### DRAWINGS—REFERENCE NUMERALS

14 lower vertical platform
16a fastener
16b fastener
16c fastener
16d fastener
16f fastener
16g fastener
16i fastener
16j fastener
16k fastener
16m fastener
16n fastener
16p fastener
18 spring assembly
20a T-attachment
20b T-attachment
22a ski
22b ski
24 hub assembly
26 lateral platform
28 footpad assembly
30 steering shaft fitting
32a upper steering spring
32b lower steering spring
34a upper steering shaft
34b lower steering shaft
36 ski spud
38a spring
38b spring
38c spring
38d spring
40 hollow pin
42a center pin
42b center pin
44 steering bushing
46 main unit
48 washer
50 main spring
52a hub
54 snap pin
56a snap spring
56b snap spring
58a spud
58b spud
58c spud
58d spud
60 footpad
62a foot spring rod
62b foot spring rod
64 front lateral platform
66 rear lateral platform
68 link assembly
70 hub and spud assembly
72a pin
72b pin
72c pin
74 link
76 front wheel assembly
78 rear wheel assembly
80a wheel
80b wheel
82a front wheelbase
82b rear wheelbase
84 handlebars

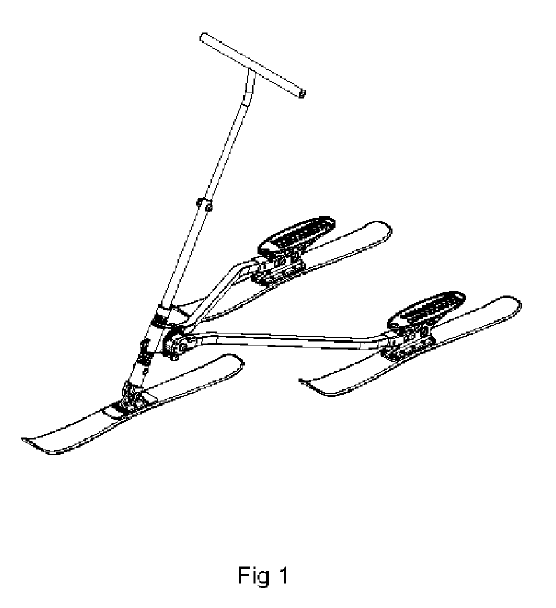

### Detailed Description—Preferred Embodiment—FIGS. 1, 2, 3, 4, 5, 6, 7

Referring now to the drawings:

FIG. 1 shows the tri-control platform in perspective view.

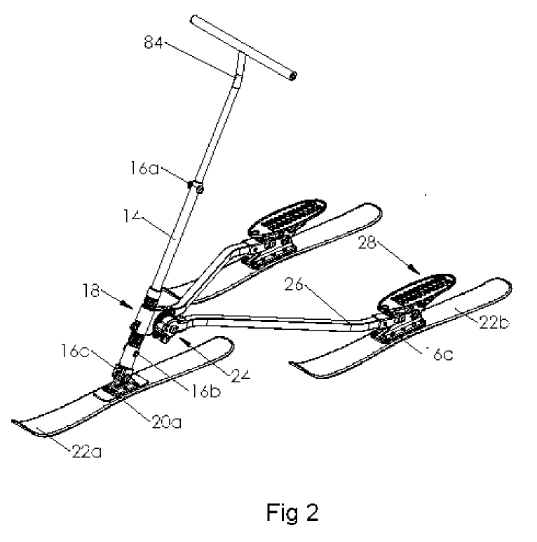

FIG. 2 shows the major parts and assemblies to the tri-control platform device in perspective view. The handlebars of the vertical platform (84) are attached to the lower vertical platform (14) and are fastened together with a fastener (16a). The spring assembly (18) fits on the lower vertical platform (14) and is fastened with a fastener (16b). The spring assembly (18) is also attached to a T-attachment (20a) using a fastener (16c). The T-attachment (20a) attaches a front ski (22a) to the spring assembly (18). The hub assembly (24) attaches the lateral platforms (26) to the lower vertical platform (14). The lateral platform (26) is attached to a footpad assembly (28) with a fastener (16d). The footpad assembly (28) is attached to the rear ski (22b).

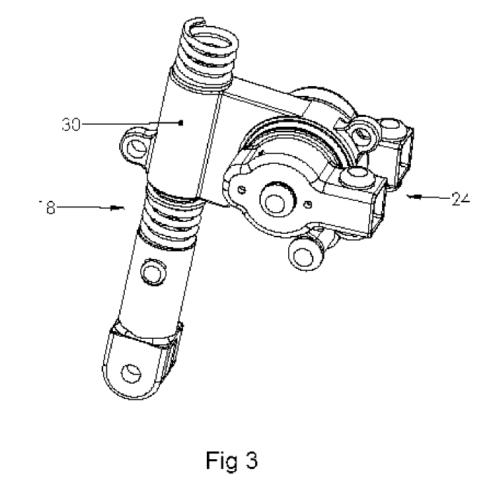

FIG. 3 shows the spring hub assembly which consists of the spring assembly (18) and the hub assembly (24). They are connected together with the steering shaft fitting (30).

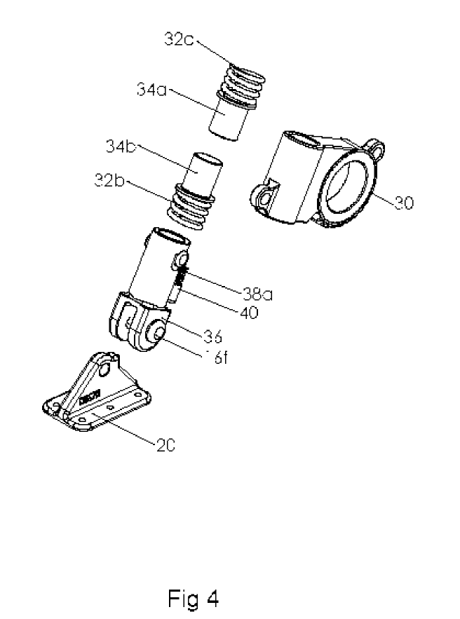

FIG. 4 is a detailed exploded view of the spring assembly and steering shaft. The upper steering spring (32a) rests on top of the upper main steering shaft (34a). The upper main steering shaft (34a) and the lower main steering shaft (34b) slide into the steering shaft fitting (30). The lower main steering shaft (34b) rests against the lower steering spring (32b). The ski spud (36) rests against the lower steering spring (32b). The ski spud (36) contains a spring (38a) and a hollow pin (40) and is attached to the T-attachment (20) with a fastener (16f).

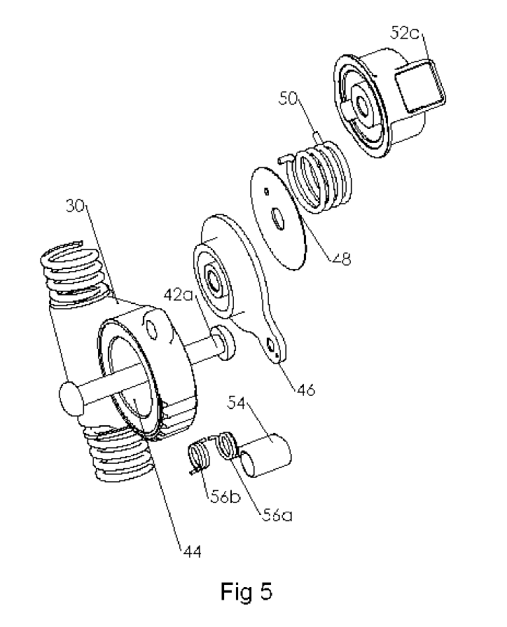

FIG. 5 shows the hub assembly exploded. The hub assembly is attached to the rear of the steering shaft fitting (30). The center pin (42a) holds the hub assembly together. Inside of the steering shaft fitting (30) is a steering bushing (44). The main unit (46) is the first part on the center pin (42a). Attached next is a washer (48), followed by the main spring (50), and held together with the hub (52a). On the underside of the steering shaft (30) is a snap pin (54) with two snap springs (56a and 56b) inside.

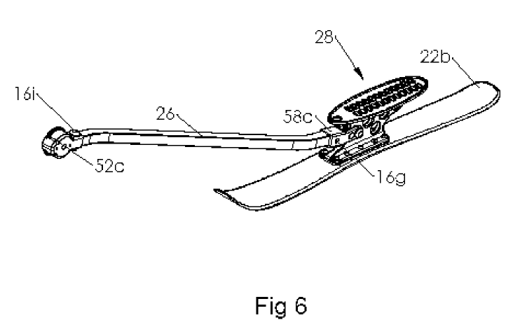

FIG. 6 shows the left lateral platform. Both the left and right sides are built in the same manner, but assembled in a rotated manner (not mirrored). The hub (52a) is attached to the lateral platform (26) with a fastener (16i). The lateral platform (26) is attached to the spud (58a) with a fastener (16g). The footpad assembly (28) is attached to the rear ski (22b).

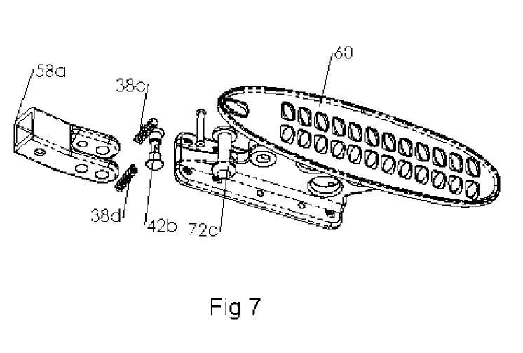

FIG. 7 shows the footpad assembly exploded. The footpad (60) is attached to the spud (58a) with a pin (72c) through the hole closest to the footpad (60). Resting on the underneath side of the footpad (60) is a spring (38c). The spring (38c) then rests on center pin (42b). On the underside of the center pin (42b) is another spring (38d). The center pin (42b) is attached to the spud (58a) through the middle hole.

### Operation—Preferred Embodiment—FIGS. 1, 2, 3, 4, 5, 6, 7

In operation, when the operator travels down a hill and shifts his or her weight from side to side using both the footpads and the handlebars, the vehicle will turn in the direction that the rider has shifted his or her weight. The hub assembly will keep the rear skis parallel and the skis will move to allow the rider to ski the edge of the skis. The rider can lift the front ski off the ground to avoid obstacles. The rider can also move the back ski tips off the ground with his or her foot to avoid obstacles. The spring action in the footpad assemblies allows the ski to return to its normal position. The handlebars can be adjusted to different angles. The handlebars also will collapse when a certain amount of pressure is applied to avoid hitting the rider in the event the rider falls.

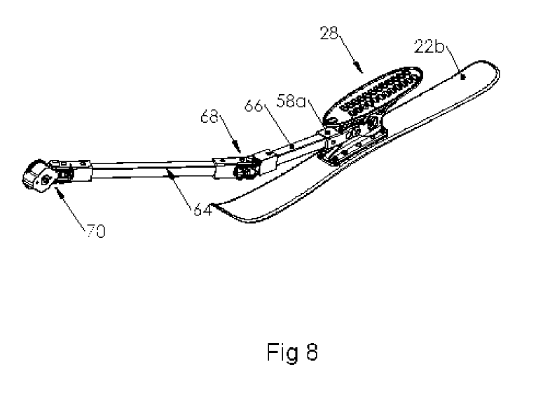

### Description—Alternative Embodiment—FIGS. 8, 9, 10

FIG. 8 consists of the adjustable platform for the tri-control platform device. The adjustable version is built in the same manner that the original version is built except for the lateral platforms. The front lateral platform (64) is attached to the rear lateral platform (66) with a link assembly. (68). The front lateral platform (64) is attached to a front hub and spud assembly (70). The rear lateral platform is attached to the footpad assembly (28) with a spud (58a). The footpad assembly (28) is attached to the ski (22b).

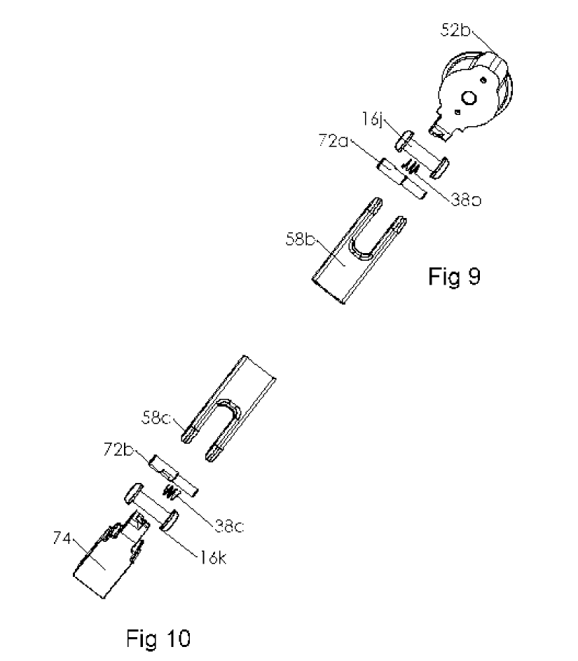

FIG. 9 shows the front hub and spud assembly for the adjustable lateral platform. The hub (52b) is attached to the spud (58b) with a fastener (16j). Inside of the spud (58b) is a pin (72a) that the spring (38b) slides onto.

FIG. 10 shows the link assembly for the adjustable lateral platform. The spud (58c) is attached to the link (74) with a fastener (16k). Inside of the spud (58c) is a pin (72b) that the spring (38c) slides onto.

### Operation—Alternative Embodiment—FIGS. 8, 9, 10

The version of the tri-control platform device with the adjustable lateral platforms is an additional embodiment. It allows the rider to adjust the width of the platforms for rider comfort.

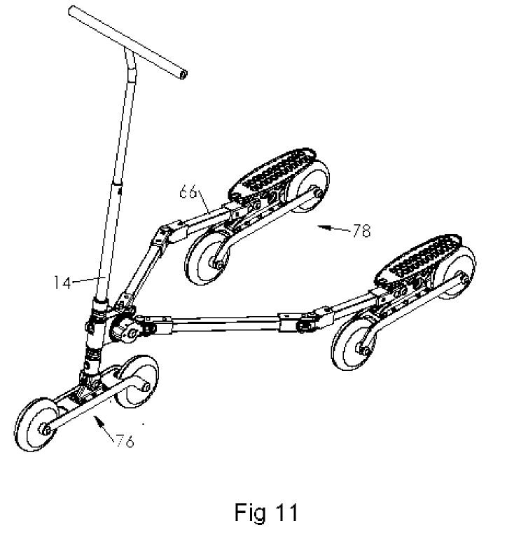

### Description—Additional Embodiment—FIG. 11, 12, 13

FIG. 11 is a perspective view of the tri-control platform device with wheels. Attached to the lower vertical platform (14) is the front wheel assembly (76). Attached to the rear adjustable platform (66) is the rear wheel assembly (78).

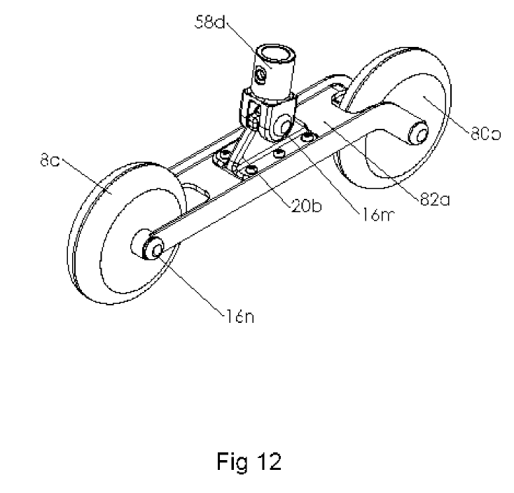

FIG. 12 is a detailed perspective view of the front wheel assembly. The spud (58d) is attached to the T-attachment (20b) with a fastener (16m). The T-attachment (20b) it attached to the front wheelbase (82a). The wheel (80a) is attached to the front of the front wheelbase (82a) with a fastener (16n) and the wheel (80b) is attached to the back end of the front wheelbase (82a).

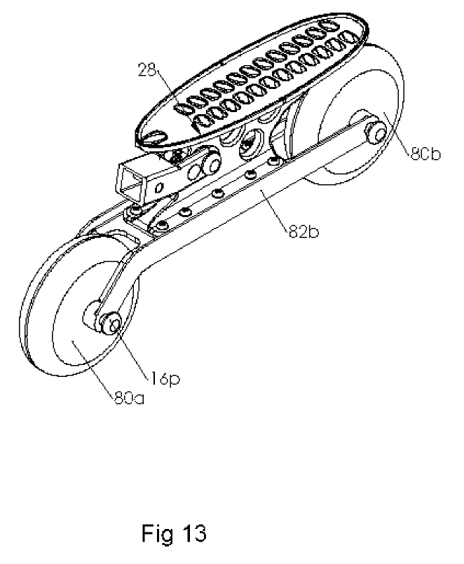

FIG. 13 is a detailed perspective view of the rear wheel assembly. The footpad assembly (28) is attached to the rear wheelbase (82b). The wheel (80a) is attached to the front of the rear wheelbase (82b) with a fastener (16p) and the wheel (80b) is attached to the back end of the rear wheelbase (82b).

### Operation—Additional Embodiment—FIGS. 11, 12, 13

An additional embodiment is a wheel attachment for the tri-control platform device. This works in the same manner as the above tri-control platform device except that it has wheels rather than skis. Each wheel assembly has two wheels giving the device stability and imitating downhill skiing. If used on flat pavement, the rider will need to push off to start rolling. To stop the device from rolling, the rider pulls back on the handlebars. This pushes the lateral platforms against the wheels and stops the device.

### CONCLUSION, RAMIFICATIONS, AND SCOPE OF INVENTION

Thus the reader will see that the tri platform control device provides a highly reliable, lightweight, and compact equipment. The device can be used with skis in the snow, or wheels on the ground. Various ages and skill levels can also use it. Both the ski and wheeled versions imitate skiing, transferring skills learned to downhill skiing. The vertical platform adjusts to different angles for rider comfort. The vertical platform also collapses under specified pressure to prevent injuries. The adjustable platform model allows the rider to adjust the width for comfort and steep terrain. The device folds up for storage, transporting, and carrying at the ski area and onto lift. The front ski or wheel can be lifted off the ground with no danger of falling backwards, avoiding obstacles. Rear skis or wheels have a spring in the footpad, allowing rider to adjust angle to go over bumps, and avoid obstacles. This also allows the skis or wheels to return to normal position. The center spring hub allows more fluid turns at greater speeds. It is easy to manufacture and assemble.

While my above description contains many specificities, these should not be construed as limitations on the scope of the invention, but rather as an exemplification of one preferred embodiment thereof. Many other variations are possible. For example different sizes can be made to suit different size riders, such as children in different growth stages. A variation can also be made for the handicap. In addition to skis and wheels, floatation devices can be attached to either version for use in the water. While the wheels are shown on the version with adjustable platforms, they can also be made to go on the version without adjustable platforms. The tri platform control device can also be modified to allow the unit to become a cart for carrying objects, such as golf clubs or shopping. The ring feature on the hub allows the platform to able to tow or be towed. A kite or towrope may be attached to the hub ring to aid in motion. The aft hub ring may be used to tow a sled or ski patrol toboggan.

While this model is made consisting of mostly metals, future models can be made of various types of plastic. This tri platform control device can be made in a variety of colors to suit different tastes

Accordingly, the scope of the invention should be determined not by the embodiments illustrated, but by the appended claims and their legal equivalents.

What is claimed is:

1. A tri platform control device comprising:
a front vertical platform,
a spring assembly attached to said vertical front platform by a steering shaft fitting,
a first hub assembly and a second hub assembly attached to said spring assembly,
a first lateral platform attached to said first hub assembly,
a second lateral platform attached to said second hub assembly,
a first footpad assembly attached to said first lateral platforms,
a second footpad assembly attached to said second lateral platform,
said footpad assemblies have attached an item selected from the group consisting of skis and a back wheel assembly, and
said front vertical platform has attached an item selected from the group consisting of a ski and a front wheel assembly.

2. The tri platform control device of claim 1, wherein said spring assembly includes an upper steering spring resting on top of an upper main steering shaft, a lower main steering shaft resting on a lower steering spring held together on said front vertical platform by said steering shaft fitting, and attached to said vertical front platform is a ski spud containing a snap pin.

3. The tri platform control device of claim 1, wherein said hub assembly includes a bushing, a main unit a washer, a main spring on a center pin held together with a hub on said steering shaft fitting with a snap pin on the underside of said steering shaft fitting.

4. The tri platform control device of claim 1, wherein said footpad assembly includes a footpad with an upper spring, a center pin, and a lower pin on the underside of said footpad.

5. The tri platform control device of claim 1, wherein said rear wheel assembly includes two wheels attached to a wheel base, attached to said footpad with an upper spring, a center pin, and a lower pin on the underside of said footpad.

6. The tri platform control device of claim 1, wherein said front wheel assembly includes two wheels attached to a wheelbase, attached to a T-attachment, attached to a spud.

7. A tri platform control device comprising:
a front vertical platform,
a spring assembly attached to said vertical front platform by a steering shaft fitting,
a first hub assembly and a second hub assembly attached to said spring assembly,
a first lateral adjustable platform with a link assembly attached to said first hub assembly,
a second lateral adjustable platform with a link assembly attached to said second hub assembly,
a first footpad assembly attached to said first lateral platforms,
a second footpad assembly attached to said second lateral platform,
said footpad assemblies have attached an item selected from the group consisting of skis and a back wheel assembly, and
said front vertical platform has attached an item selected from the group consisting of a ski and a front wheel assembly.

8. The tri platform control device of claim 7, wherein said link assembly includes a spud with pin with a spring that slides onto said pin inside of said spud attached to a link.

9. The tri platform control device of claim 7, wherein said hub assembly includes a spud with a pin with a spring that slides onto said pin inside of said spud attached to a hub.
